(19) United States
(12) Patent Application Publication
(10) Pub. No.: US 2004/0059691 A1
(43) Pub. Date: Mar. 25, 2004

(54) Method for marketing energy-use optimization and retrofit services and devices

(76) Inventor: Robert L. Higgins, Henderson, NV (US)

Correspondence Address: David Comarrow, Esq., 10561 Haven St., Las Vegas, NV, 89123, US

(21) Appl. No.: 10/252,130

(22) Filed: Sep. 20, 2002

(51) Int. Cl. G06F 17/60

(52) U.S. Cl. 705/412; 705/1

(57) ABSTRACT

A method is disclosed for marketing energy-use optimization and retrofit services and devices. The first step in the present method is to measure empirical (base-line) performance including energy use and efficiency. A best-fit curve is generated and defined by at least a third-degree polynomial. Second, the theoretical performance of the system is calculated based upon the theoretical implementation and installation of proposed strategies and devices (the “Proposa”). Third, the projected savings are presented to the client and a fee structure is established based, at least in part, on energy savings resulting from implementation of the Proposal. Fourth, the actual performance of the completed implementation of the Proposal is measured. Fifth, post-implementation measured energy use is compared with pre-implementation energy use at specific pre-determined “part load” levels. The polynomial defining pre-implementation energy use at specific part load levels is applied to post-implementation measured values to eliminate extraneous factors such as weather. Sixth, the client is billed according to the fee structure. The fee structure may be linear or may increase per unit of energy saved as savings approach or exceed the theoretical maximum. The present invention may be used for marketing energy-saving retrofit systems and strategies, as well as alternate energy installations.

### REFERENCE TO PRIOR-FILED APPLICATION

None.

### FIELD OF THE INVENTION

The invention relates generally to methods for marketing and selling energy-saving consulting services and devices, and more particularly to methods for effectively demonstrating energy and cost savings from implementation of certain services or installation of devices or systems, and for charging for such services and/or devices according to actual savings.

### Background of the Invention

Energy conservation has become a critical component in profitability of businesses having large facilities. Energy costs continue to rise as resources become increasingly scarce and environmental concerns such as the need for pollution control and reclamation of mined areas increase the incremental cost to the end-user.

Large users of energy such as hotels, office buildings and the like have found the need to conserve energy (or collect energy from alternate sources such as solar) is now critical to profitability. Public and non-profit facilities such as schools, universities, hospitals, and civic buildings must divert limited financial resources from their primary missions to pay for energy. Therefore, many energy conservation strategies and devices have been developed over the past several decades. On a smaller scale, individual families are faced with ever-increasing utility bills, sometimes forcing the choice between living needs and paying for electricity, gas, or oil.

Certain conservation measures have proven to be highly cost-effective, while others have not. The capital cost of certain approaches, particularly retrofit strategies, can far outweigh the present value of savings so realized. For example, at present, a photovoltaic installation to convert solar energy into electricity costs an average of about $50 per peak watt. The payback for such an installation would likely exceed the life of the installation in every part of the United States, even at expected increases in the cost of power over the next two decades.

On the other hand, certain strategies are highly cost-effective. For example, adding insulation to a poorly insulated building has a highly favorable life cycle return in most climates. Likewise, so does weather stripping, adding a second pane to fenestration devices and installing window over-hangs (e.g., awnings) on South-facing exposed windows.

In large installations such as hotels, the systems for ventilation, heating and cooling are significantly more complex than for single family homes, for example. Such installations generally include cooling towers and circulated chilled or heated water to numerous air-water heat exchangers in air plenums distributed strategically throughout the facility, as well as a central control system to control the flow of chilled or heated water, air circulation etc. Such systems contain surprisingly high sources of parasitic energy loss. The cost of designing and maintaining a retrofit which saves significant amounts of energy in such complex systems can run hundreds of thousands to millions of dollars to implement, and similar amounts annually to maintain. Yet, if done correctly, the savings can greatly outweigh the expenses, both on an annualized basis, and on a life-cycle basis.

The present inventor has carried out extensive modeling and empirical measurement to develop a comprehensive strategy for large Heating, Ventilation and Air Conditioning (HVAC) installations. However, to convince potential users of the surprisingly large energy and cost savings, the method of the present invention was employed. Without the method of this invention it is doubtful that large hotels and the like would invest the large sums needed to install and maintain their conservation systems. The energy savings have been dramatic, resulting in savings for the end user, energy savings for the nation and reduced pollution, strip mining and nuclear waste from power generation. The method of the present invention has been so successful, that it was found it can equally apply to any truly cost-effective energy conservation or alternate energy generation installation or consulting for both large and small installations.

### DESCRIPTION OF RELATED ART

Energy conservation consulting and retrofit is a sophisticated, growing business. Especially in large installations, surprisingly large percentages of total energy use can be reduced by eliminating parasitic losses, particularly from chilled or heated water circulation. pumps. See e.g., Kreutzmann, Campus Cooling: Retrofit Systems, HPAC Engineering, July 2002 <http://www.hpac.com/member/feature/2002/0207/0207kreutzmann.htm>. See also Shiming, Sizing Replacement Chiller Plants, ASHRAE Journal, June 2002, vol.__, no.__. See also Fiorino, Achieving High Chilled-Water Delta Ts, ASHRAE Journal, November 1999, vol.41, no.11. See also, U.S. Pat. No. 5,040,725 to Butler disclosing a system for cost-optimizing a hot water space heating circulation system.

In general terms, by employing digital electronic speed controls on system circulation pumps and air handlers (fans), improved valve and damper technology, and reconfiguring various flow paths, the delta T across the system heat exchangers can be optimized, reducing the electrical use by the pumps and fans and increasing the overall system efficiency. The present inventor has learned from his experience in the field that convincing the owners or decision-makers in large institutions of the economic benefits of an optimization implementation is both difficult and the key to making it happen.

Prior approaches generally lack the ability to adequately compare pre-implementation with post implementation performance of an optimized HVAC system without instrumenting each component of the system, and have additional disadvantages. For example, in U.S. patent application Ser. No. 2002/0007388 made by Bannai et al., discloses a method by which an energy service business finances the up-front installation costs and then collects for those costs out of the energy savings. One disadvantage of this concept is that it requires the energy service company to finance all consulting and installation. In addition, as has become clear to the present inventor, it is extremely difficult to accurately determine the source of energy savings after a retrofit or adjustment in operating procedures in HVAC systems since many factors change from the time before the system is retrofitted until after the job is complete. The weather is different, occupancy loads vary, other changes to the building may be carried out etc. The present invention allows the consultant to account for these changes without the need to measure the energy use of each component in the system (which would be expensive and impractical).

As will be made clear, development of the present methodology was found to be applicable to a broader scope than just large HVAC systems, including energy conservation (such as retrofitting insulation) and alternate energy installations (such as solar thermal domestic hot water).

Definitions

For clarity and for the avoidance of ambiguity, the following definitions shall be used for interpreting the meaning of words throughout this Application, including all claims.

Client shall mean any actual or potential end-user or agent of such end-user of services or products being marketed or sold using the present invention.

Energy conservation shall mean any means for method employed to save energy including optimizing performance of energy-consuming systems, using alternate energy sources (e.g., solar, wind, geothermal, wave energy, ocean thermal energy, insulation, energy-conserving windows (multi-pane, infrared reflective, etc.)

Energy-consuming systems shall mean any device or system that utilizes energy. These include, but are not limited to, HVAC systems, lighting, transportation (e.g., autos, trucks, trains, aircraft, elevators, escalators), displays (e.g., video displays, moving signs), food preparation facilities, dishwashing facilities, laundries, material conveyance (conveyers, lifts), manufacturing machinery, and the like.

HVAC shall mean a heating, ventilation and/or air conditioning system. HVAC shall refer to all portions of such system including, but not limited to compressors, chillers, pumps, air handlers (fans), heat exchangers, exterior cooling towers, earth-coupling systems (heat sinks), auxiliary (stand-by) power sources, controls, filters and air cleaners.

Implementation shall mean installation of energy conservation equipment or alternate energy generation equipment, or the initiation of energy conservation strategies or consulting.

Optimized shall mean changes made in an energy-consuming system to improve its energy efficiency. These may be operational changes, installation of energy saving devices, replacement of components with more efficient devices, improved control strategies, or other system changes intended to save energy.

Part Load shall mean standardized percentages of the maximum cooling or heating load of an HVAC system: 25%, 50%, 75% and 100%.

### SUMMARY OF THE INVENTION

Accordingly, it is an object of the present invention to provide a method for demonstrating to a Client the expected energy and cost savings of a proposed product or service, then measuring the actual savings using pre-implementation empirical measurements as the base reference, and charging for the products and/or services at least partly on the basis of the savings experienced..

It is further an object of the present invention to provide a mathematically sound approach for using base-line energy use measurements to determine actual post-implementation savings, without distortion from variations in weather, use patterns, and the like.

### BRIEF DESCRIPTION OF THE DRAWINGS

FIG. 1 is a is a flow chart illustrating the steps of the present invention used to measure actual performance post-implementation.

FIG. 2 is a is a flow chart illustrating the steps of the the present invention used to project energy costs of an optimized (post-implementation) plant.

FIG. 3 is a spreadsheet showing an example Part Load analysis for an as-built chilled d water HVAC plant.

FIG. 4 is a spreadsheet showing an example Part Load analysis for a proposed optimized chilled d water HVAC plant.

FIG. 5 is a second degree polynomial graph of KwH vs. cooling capacity (“tons”) comparing the as-built and the proposed optimized plants.

FIG. 6 is a flow chart describing the steps used in monitoring a post-optimized plant.

### DETAILED DESCRIPTION OF THE INVENTION AND ITS PREFERRED EMBODIMENTS

The present invention represents a methodology for establishing a baseline energy use/cost for an as-built energy consuming device, a method for projecting savings resulting from implementation of recommended design or operational changes, a method for accurately isolating and measuring savings resulting from implementation of such changes, and a method for charging a Client based, at least in part, based upon actual savings realized. The critical core of the invention is a way of computing actual savings of a post-implementation system without distortion from extraneous factors such as weather changes, and without the need to meter (instrument) each and every subcomponent of the system. Normally, according to this invention, a performance-based agreement is entered into under which the Client will pay a fee that is at least partly based upon projected or actual savings realized from the optimization/retrofit strategy implemented. There my be incentives for approaching or exceeding projected savings, or penalties for not reaching certain savings levels. The fee may simply be set as a percentage of savings (e.g. 50%). Alternatively, the fee paid by the Client may increase either linearly or exponentially as the actual savings approach or exceed the projected savings. Hence it is critical to clearly identify actual savings resulting from implementation of the recommended strategy.

While we refer to “as-built” and “post implementation” systems, the present invention may also be used to compare alternative systems and devices in new construction.

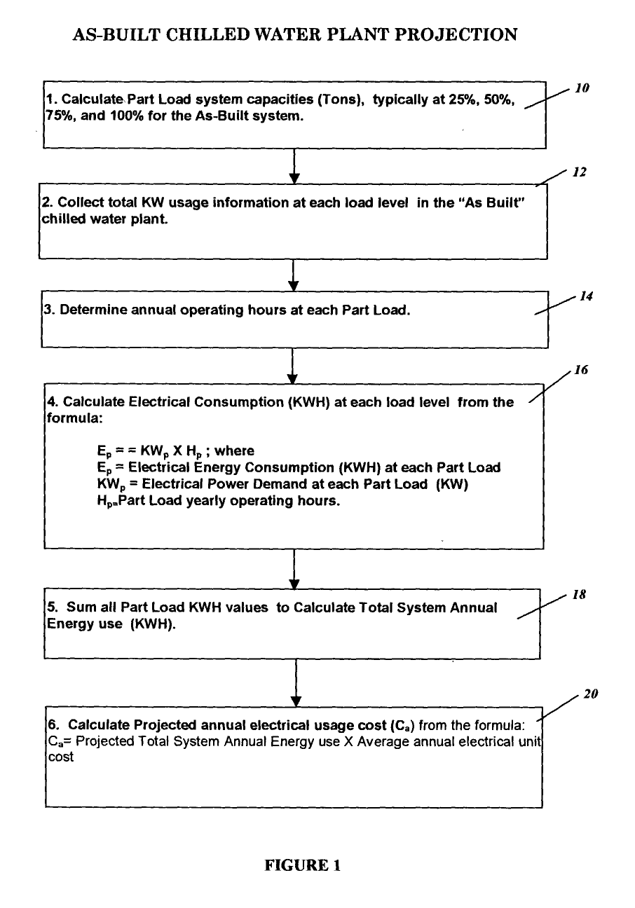

FIG. 1 is a flow chart illustrating the steps of the method used to measure actual performance post-implementation. Step 1, “Calculate Part Load system capacities (Tons), typically at 25%, 50%, 75%, and 100% for the As-Built system.” 10 is generally carried out by reference to the design documentation for the entire system, as well as component name plate data. The system will have a maximum (100%) design load, as well as design 75%, 50% and 25% Part Loads (representing fractional capacities). These figures will normally be available as part of the system design and engineering documentation. Such data will generally be in the form of “cooling tons” (each ton=12000 BTU/hour). For example, a commercial central cooling system may be rated for “100 tons” meaning at its peak cooling capacity it can cool a the rate of 12,000,000 BTUs per hour. In such a system, the Part Loads would be 25 tons, 50 tons, 75 tons and 100 tons. Such system evaluation and rating is well known in the art and may be carried out by an HVAC engineer. It should be noted that it is assumed that the system only runs at one of the Part Loads. Each Part Load value actually represents the top of the range for that Part Load (i.e., 1%-25%, 26%-50%, 51%-75%, 76%-100%). This approximation greatly simplifies modeling and turns out to be highly accurate over a long period of time. The concept of using these Part Loads is well known in the HVAC industry and to HVAC engineers.

Step 2 of FIG. 1, “Collect total KW usage information at each load level in the “As Built” chilled water plant.” 12 is a matter of inspecting each pump, fan etc., or data sheets on record, and recording the electrical rating for each.

Step 3 of FIG. 1 “Determine annual operating hours at each Part Load,” 14 is carried out by reference to historical operating logs for the specific facility (where it is an as-built plant). Such logs will provide accurate estimates of the number of hours each plant operated at the standard Part Loads each year. For example, a particular plant may run 1000 hours at an average of 25% Part Load (I.e. 25% of its rated capacity), 2000 hours at 50% Part Load, 2500 hours at 75% Part Load and 500 hours at 100% Part Load. Each Part Load will include the hours run within a range having an approximate maximum of the Part Load. For example, 25% Part Load will include the number of hours the plant runs annually from about 1% to 25%%; 50% Part load will include the total hours the plant runs annually at between 26% and 50%, etc.

Where the client wishes more precise validation, an engineering study may be carried out, typically taking a year or more. Normally, the Client will pay for the validation study, although the cost may be partly or fully borne by the consultant.

Step 4 of FIG. 1, “Calculate Electrical Consumption (KWH) at each load level from the formula: E==KWp X Hp; where Ep=Electrical Energy Consumption (KWH) at each Part Load; KWp=Electrical Power Demand at each Part Load (KW); Hp=Part Load yearly operating hours” 16 is the process of determining the annual energy use at each Part Load Capacity. For example, at 25% Part Load, the system might draw 400 KW and run a total of 1000 hours per year at 25% capacity., This means the system will use 400,000 KwH of energy per year when running at its 25% Part Load. Similarly, it might draw 600 KW when running at 50% Part Load, and runs 4,000 hours annually at 50% Part Load. Therefore the system would consume 2,400,000 KwH annually when running at 50% Part Load. Similar calculations are also carried out for 75% and 100% Part Load, and the total annual electrical use is totaled for the as-built system.

Step 5 of FIG. 1 “Sum all Part Load KWH values to Calculate Total System Annual Energy use (KWH)” 18 means adding the four its projected energy uses at each Part Load from Step 4. This gives the annual energy use of the as-built system. In addition, it provides data points at each Part Load with which the post-implementation model may be compared. The figure may also be validated by metering the total energy usage of the load centers serving the as-built plant with a standard totaling (integrating) meter.

Step 6 of FIG. 1 “Calculate Projected annual electrical usage cost (Ca) from the formula: Ca=Projected Total System Annual Energy use X Average annual electrical unit cost” 20 gives the as-built projected base-line annual electrical cost. The electrical unit cost is a calculated average unit cost for the particular customer. It should be noted that certain conservation strategies, such as load shifting, may further reduce the unit cost as well. The projected annual electrical usage cost is useful for many reasons, notably it breaks out the energy cost for the HVAC system from all other electrical uses. It also provides a key benchmark for comparing post-implementation costs.

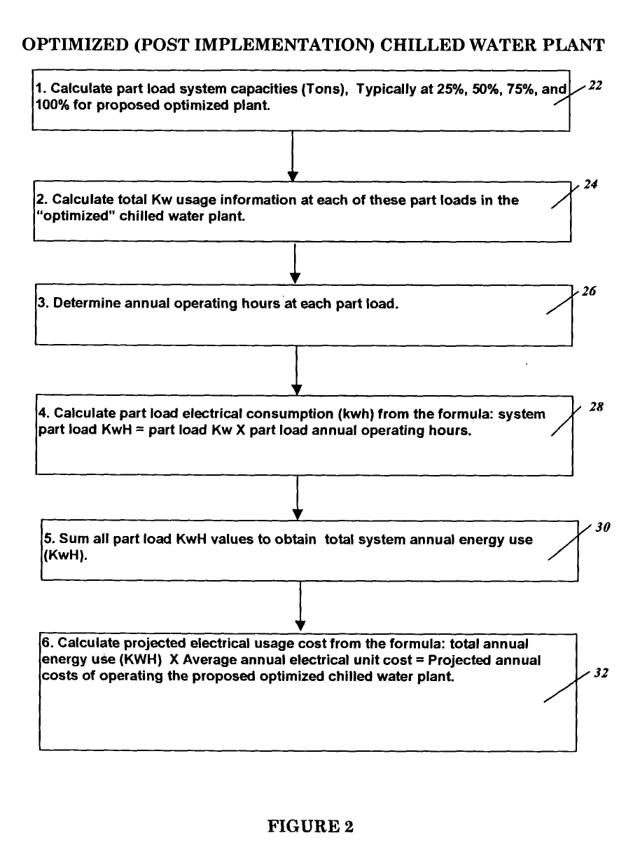

FIG. 2 is a flow chart illustrating the steps of the method used to project energy costs of an optimized (post-implementation) plant. Once the plant is optimized, it is critical to the present invention to be able to determine the amount of energy the plant is using and compare it with the pre-implementation plant, without variations from extraneous factors such as varying weather. Therefore, the same methodology that was used in the as-built plant is applied to the post-implementation (optimized) plant.

Step 1 of FIG. 2, “Calculate Part Load system capacities (Tons), typically at 25%, 50%, 75%, and 100% for proposed optimized plant”22 will have already been carried out as step 1 of FIG. 1 related to the as-built plant. The assumption here is the building being cooled and/or heated by the plant is not changing, the efficiency of the HVAC system is being improved. Therefore the cooling/heating capacities and numbers of hours per year expected at each Part Load should not vary significantly as a result of the implementation of the improvements being marketed with the present invention.

Step 2 of FIG. 2, “Calculate total KW usage information at each of these Part Loads in the “OPTIMIZED” chilled water plant” 24 is carried out with a straight-forward summing of the electrical ratings for all electrical components in the proposed (Optimized) system, deleting any components that will be removed. This will yield a total KW rating at 100% load, Simple division yields the KW rating for the system at 75%, 50% and 25% Part Loads.

Step 3 of FIG. 2, “Determine annual operating hours at each Part Load” 26 is taken from the analysis carried out on the as-built system (step 3 of FIG. 1 14). The annual hours the system will operate at each Part Load will not change as a result of operating more efficiently. Only the total electrical usage will be reduced for the same amount of cooling.

Step 4 of FIG. 2, “Calculate Part Load Electrical Consumption (KWH) from the formula: System Part Load KWH=part load KW X Part Load annual operating hours” 28 is the process of determining the annual energy use at each Part Design Load for the optimized plant. For example, at 25% Part Design Load, the system might draw 300 KW. Since it will run 1000 hours at 25% capacity, this means the system will use 300,000 KwH of energy when running at its 25% of capacity. Similarly, it might draw 500 KW when running at 50% of its capacity and, since it might run 4000 hours annually at 50% capacity, would consume 2,000,000 KwH annually when running at 50% of its Part Design Load. Similar calculations are also carried out for 75% and 100% Part Loads. These data points are easy to graph as a first or second degree polynomial to compare the as-built with the proposed optimized plant efficiencies at each Part Load.

Step 5 of FIG. 2, “Sum all Part Load KWH values to obtain Total system annual energy use (KWH)” 30 means adding the four projected energy uses at each Part Design Load from Step 4 28. This gives the measured annual energy use of the proposed Optimized system. In addition, it provides data points at each Part Design Load with which the post-implementation model may be compared.

Step 6 of FIG. 2, “Calculate projected electrical usage cost from the formula: Total annual energy use (KWH)×Average annual electrical unit cost=Projected Annual costs of operating the proposed optimized chilled water plant” 32 gives the optimized projected annual electrical cost.

The foregoing steps in FIGS. 1 and 2 taken together represent the methodology for preparing a presentation to sell a proposed system or strategy. Once a Client approves the proposal, it will generally be necessary to be able to distinctly verify the savings resulting from the implemented strategy, without unwanted variations caused by extraneous factors. Therefore, a post-implementation validation is carried out as described below.

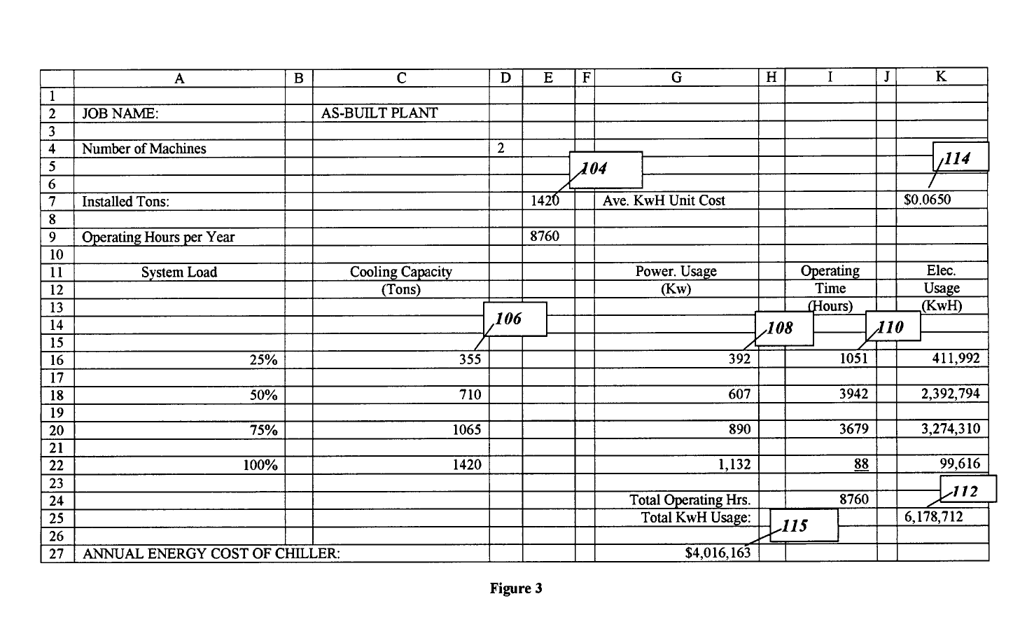

FIG. 3 is a spreadsheet showing an example Part Load analysis for an as-built plant. This installation has a maximum capacity (100% Design Load) of 1420 tons 104. At it maximum capacity, the system will draw 1,132 KW. The Part Load tons are straight percentages of the maximum capacities: 25% Part Load is 355 tons 106 and will draw 392 KW 108. The system is expected to run 1051 hours 110 at 25% load annually, yielding an annual electrical usage of 411,992 KwH for all hours the system runs at 25% Part Load. Similarly, the annual electrical use is computed for 50%, 75% and 100% loads, and the annual electrical usage is summed 112. An assumed annual average unit cost of electricity is used, here $0.65 per KwH 114, yielding a total annual electrical cost 115.

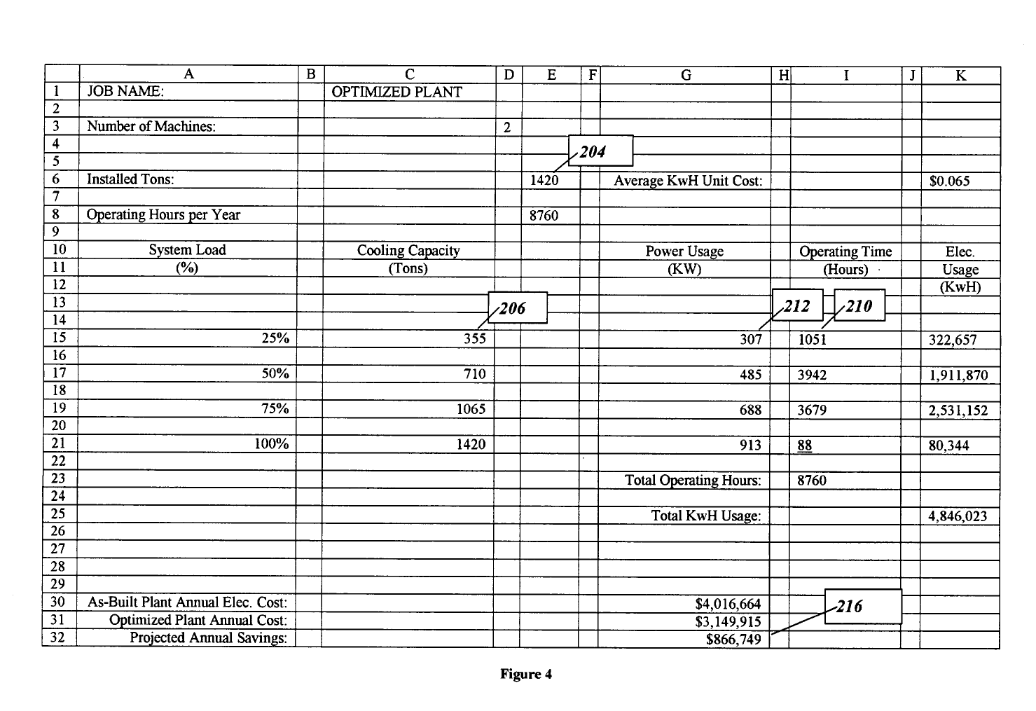

FIG. 4 represents the same kind of analysis carried out in FIG. 3, except for the proposed optimized plant. Comparing FIGS. 3 and 4, it may be seen that the optimized plant has the same total cooling capacity 204 as the as-built plant, including the Part Loads. Moreover, the numbers of hours annually the system will be required to run at each Part Load will not change 210. Notably, the electrical usage will be lower owing to the improvements anticipated to be made 212. The bottom line shows a projected annual savings over the as-built plant of $866,749 216.

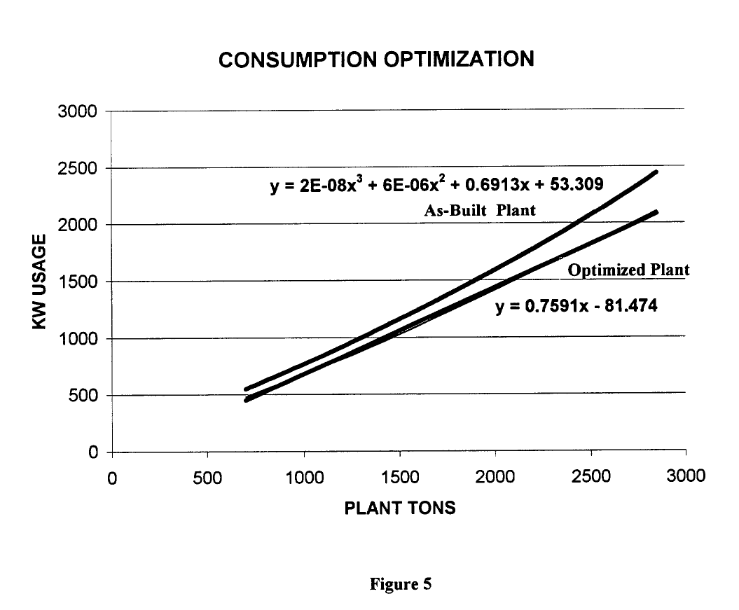

FIG. 5 is a second degree polynomial graph of KwH vs. cooling capacity (“tons”) comparing the as-built and the proposed optimized plants. The polynomial, a best-fit curve, represents an empirically-created mathematical model of the system, and therefore it is validated for the particular installation. The graph was generated by using Microsoft Excel 2000 by the following steps using example data:

a) Determine the Part Load system capacities at 25%, 50%, 75% and 100% from design or historical logged information;

b) Determine power (KW) usage at each of these part load system capacities by averaging several (at least four) instantaneous power (KW) readings at each part load (do not use outliers).

c) Build a spreadsheet from the collected information in the following manner (example data points):

| PART LOAD CAPACITY | TONS | KW |
|---|---|---|
| 25% | 350 | 400 (average of 4 readings) |
| 50% | 700 | 850 (average of 4 readings) |
| 75% | 1050 | 1375 (average of 4 readings) |
| 100% | 1400 | 1800 (average of 4 readings) |

d) Select the “chart wizard” (or similar) function from the drop down menu of the Excel (or equivalent) program.

e)Select the “chart type” as a X/Y scatter with data points connected by smooth lines without markers. This will generate a graph of a Cartesian plane for the purpose of plotting points (part load capacity and corresponding KW) in an X, Y coordinate system. Later, as more fully herein described below, these data points will be connected, and a “best fit” line equation will be generated.

f) There will be two line equations generated so name this one the “As Built Plant”.

g) Label the Y axis “KW” Label the X axis “Tons.”

h). Select the four part load capacity data points (tons) as the X axis values (350, 700, 1050, 1400) and the four corresponding KW data points (400, 850, 1375, 1800) as the Y axis values.

i) Select the “add trendline/show equation” option (3rd level polynomial).

j.) Select “finish.” The chart is displayed with the as-built data displayed as a “best fit” line with the corresponding line equation.

k.) Left click the computer mouse at any point on the displayed graph. Choose “add another series” of data to be plotted.

l.) Repeat steps f through k, naming this series “Optimized Plant”. Part Load Capacities and tonnage will remain the same. However, KW data points for this series will be adjusted at each corresponding part load capacity according to the expected reductions in system KW consumption based on optimization strategies implemented.

m.) When all steps are completed a chart is displayed with two lines, labeled “As Built Plant” and “Optimized Plant” with their corresponding line equations.

This graph permits the Client to directly visualize the actual savings realized by the implementation strategy.

The plant is monitored on a continuing basis using well-known purpose-built microprocessors for control and monitoring of pumps, fans, dampers etc. A good example is Trane's “Tracer Summit” product which is connected to thermocouples and flow meters. The microprocessor of the Trane system runs proprietary software having its own programming language (“CPL”) allowing the present system to be implemented as needed. The system calculates tonnage (from flow and temperature). Tracer outputs to a standard personal computer. The system tonnage is measured each minute, then summed each hour and each day to calculate the total cooling tons used per day/month/year. Tons are directly determined by measuring flow rate of chilled water flowing to water/air heat exchangers and ΔT across the heat exchanger as follows:

qw=500Q×W×ΔT

where qw is BTU's.

1 ton=12,000 BTU's. This is directly convertible to electrical use (3413 BTU/KwH).

qw is then used in the polynomial generated supra to solve for Y in both pre and post optimization equations. This is solved in real time each minute, summed each hour to yield KWH's used each hour.

While it might seem straight forward to sub-meter each chiller plant in a large commercial building, in fact, it is very complex and expensive. The present method allows accurate and precise determinations of electrical use without the need to continuously measure the electrical use of each component of a chilled water system.

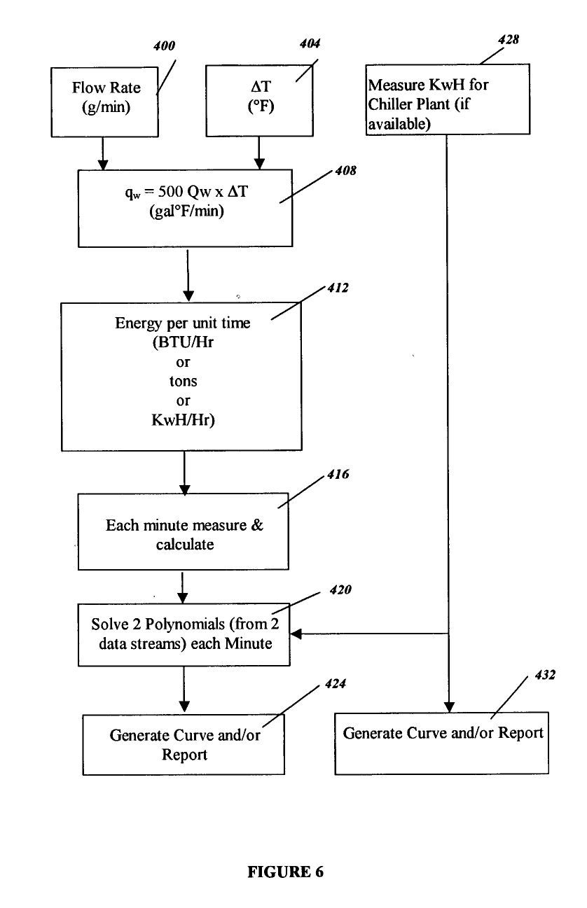

FIG. 6 is a flow chart describing the steps used in monitoring the post-optimized plant.. Flow rate is measured 400 as is ΔT across water-air heat exchangers 404. The formula qw=500 Qw×ΔT is solved each minute 408. Calculate energy used per unit time 412 each minute 416. In addition, each polynomial earlier determined for performance curves for the as-built and the optimized plants is solved each minute 420. Curves are then generated from the polynomials, as well as a report to the client 424. In addition, where possible, total electrical use of the chiller plant is continuously monitored 428 and a similar comparative curve is generated. 432.

The most important use for the initial projected savings is to convince the end user's decision makers that the proposed strategy (be it a retrofit installation, management service or engineering services) makes economic sense. The most important use for the pre-implementation measurements is to form the basis for determining actual savings and, as will become clear, the basis for charging the customer. It should be noted that normally the customer will be charged a fee for the preliminary measurements and projection modeling, although such work may be carried out at no charge or at a reduced fee as part of the process of selling the client on the proposed strategy. The work-products created with the above steps may be in the form of a graphical, tabular or narrative representation, or combinations of all three.

The most innovative aspect of the present invention is tying on-going fees to actual energy savings. In effect, if the fees are anything less than the savings, the client is ahead of the position she would have been in absent implementation of the proposed strategy.

For example, in its simplest form, the client could contract to pay an on-going fee equal to 50% of the savings realized. Many variations are, of course possible. Without limiting them in any way, and by way of example only, they can include a base minimum fee plus a percentage of savings, a straight percentage of savings, or a fixed fee not to exceed a particular percentage of savings. A bonus structure can be included for achieving a given percentage of projected savings (or exceeding the projected savings), or for achieving a particular dollar or energy savings over a given period (e.g., a year). Similarly, fees can be reduced for failure to meet projected savings. However structured, it is important to this invention that the fees charged to the client on an on-going basis, or on a periodic basis, are at least partly related to energy and/or dollar savings resulting from implementation of the proposed strategy. The key to determining energy savings attributable to the implemented strategy is to apply post implementation data at particular loads to the polynomial defined by pre-implementation empirical data selected at the same loads. Absent this approach, would be difficult or impossible to determine if energy savings were attributable to the implemented strategy or other unrelated factors (such as weather, occupancy, etc.)

The specific implementations disclosed above are by way of example and for the purpose of enabling persons skilled in the art to implement the invention only. We have made every effort to describe all the embodiments we have foreseen. There may be embodiments that are unforeseeable and which are insubstantially different. We have made every effort to describe the methodology of this invention, including the best mode of practicing it. Omission of any variation of the method disclosed is not intended to dedicate such variation to the public, and all unforeseen, insubstantial variations are intended to be covered by the claims appended hereto. Accordingly, the invention is not to be limited except by the appended claims and legal equivalents.

What is claimed is:

1. A method for marketing energy-use optimization services comprising the steps of:
a) measuring actual performance of an as-built energy-consuming installation,
b) projecting theoretical post-implementation performance of said as-built energy-consuming installation incorporating proposed optimization strategies,
c) presenting said projected theoretical optimized performance to one or more clients,
d) establishing a fee at least partly based upon actual savings,
e) implementing said optimization strategies,
f) measuring actual performance of said energy-consuming installation after said implementation of optimization strategies,
g) billing the customer according to said measured actual energy savings resulting from said implementation of optimization strategies.

2. The method as claimed in claim 1 wherein said step of establishing a fee according to projected actual energy savings is based upon said actual energy savings without regard to projected savings from said projected theoretical post-implementation performance.

3. The method as claimed in claim 1 wherein said step of establishing a fee based upon projected actual energy savings is based upon the ratio of said theoretical optimized performance and said measured actual performance wherein said fee charged increases linearly as said theoretical optimized performance increases.

4. The method as claimed in claim 1 wherein said step of establishing a fee based upon projected actual energy savings is based upon the ratio of said theoretical optimized performance and said measured actual performance wherein said fee charged per energy unit saved increases as said actual measured performance approaches or exceeds said theoretical optimized performance.

5. The method of claim 1 wherein said energy-consuming installation comprises at least an HVAC system.

6. The method of claim 5 wherein said HVAC system comprises at least one water chiller.

7. The method as claimed in claim 1 wherein said step of presenting said projected theoretical optimized performance to one or more clients includes showing said client a graphical presentation of said projected theoretical optimized performance.

8. The method as claimed in claim 1 wherein said step of presenting said projected theoretical optimized performance to one or more clients includes showing said client a tabular presentation of said projected theoretical optimized performance.

9. The method as claimed in claim 1 wherein said step of presenting said projected theoretical optimized performance to one or more clients includes showing said client a narrative presentation of said projected theoretical optimized performance.

10. The method as claimed in claim 1 wherein said step of projecting theoretical optimized performance includes the use of a mathematical model which has been empirically validated.

11. The method of claim 10 wherein said mathematical model is a polynomial generated from empirical data.

12. The method of claim 11 wherein said empirical data are collected at predetermined part load levels.

13. The method of claim 1 further comprising the steps of:
a) predetermining specific load levels,
b) creating a best-fit curve from said actual performance of an as-built energy-consuming installation at said predetermining specific load levels,
d) defining said best-fit curve as a second degree or higher polynomial,
e) selecting energy use values at said predetermined load levels from said measured actual performance of said energy-consuming installation after said implementation of optimization strategies,
f) applying said selected energy use values from said measured actual performance of said energy-consuming installation after said implementation of optimization strategies to said polynomial.

14. A method for marketing retrofit equipment comprising the steps of:
a) measuring actual energy performance of an as-built HVAC installation,
b) projecting theoretical optimized energy performance of said as-built HVAC installation incorporating proposed said retrofit equipment,
c) presenting said theoretical optimized energy performance to one or more clients,
d) installing said retrofit equipment,
e) measuring actual energy performance of said HVAC installation.

15. The method as claimed in claim 14 further including the step of establishing a post-installation service fee based on actual energy savings.

16. The method as claimed in claim 15 wherein said step of establishing a post-installation service fee based upon actual energy savings is further based upon the ratio of said theoretical optimized performance and said measured actual performance wherein said fee charged per energy unit saved increases as said actual measured performance approaches or exceeds said theoretical optimized performance.

17. The method as claimed in claim 15 wherein said step of establishing a post-installation service fee based upon actual energy savings is linear.

18. The method as claimed in claim 14 wherein said step of presenting said projected theoretical optimized performance to one or more clients includes showing said client a graphical presentation of said projected theoretical optimized performance.

19. The method as claimed in claim 14 wherein said step of presenting said projected theoretical optimized performance to one or more clients includes showing said client a tabular presentation of said projected theoretical optimized performance.

20. The method as claimed in claim 14 wherein said step of presenting said projected theoretical optimized performance to one or more clients includes showing said client a narrative presentation of said projected theoretical optimized performance.
